(19) United States
(12) Patent Application Publication
(10) Pub. No.: US 2016/0340997 A1
(43) Pub. Date: Nov. 24, 2016

(54) INSERT SLOT OF A SLIP ASSEMBLY USED IN DRILLING AND METHOD OF FORMING THE INSERT SLOT

(71) Applicant: Jeffrey Lee Bertelsen, Coldspring, TX (US)

(72) Inventor: Jeffrey Lee Bertelsen, Coldspring, TX (US)

(21) Appl. No.: 15/224,926

(22) Filed: Aug. 1, 2016

Related U.S. Application Data
(63) Continuation-in-part of application No. 14/061,974, filed on Oct. 24, 2013, now abandoned.
(60) Provisional application No. 61/719,993, filed on Oct. 30, 2012.

(51) Int. Cl. E21B 33/04; B23C 3/34; E21B 19/10

(52) U.S. Cl. CPC E21B 33/0422; E21B 19/10; B23C 3/34

(57) ABSTRACT

An insert slot for a slip segment of a rotary slip assembly is described. The insert slot includes a generally rectangular recess formed by milling a single piece of metal which is to be the slip segment, the milled recess thereby forming the insert slot, and a circular hole formed at each of two lower corner locations of the milled recess. The circular corner holes allow a dovetail cutter access into and removal from the recess to make a dovetail cut that creates an angled grove along lengthwise sides of the insert slot, the insert slot having a flat bottom adapted to support a bottom of a tool or grip insert, the insert slot formed in a single piece of metal with no other materials attached thereto, so as to permit an accurate load rating to be determined for the slip assembly.

### CROSS-REFERENCE TO RELATED APPLICATION

The present application is a continuation-in-part of an claims the benefit under 35 U.S.C. §120 of U.S. patent application Ser. No. 14/061,974 to the inventor, filed Oct. 24, 2013, pending, the entire contents of which is hereby incorporated by reference herein.

### BACKGROUND

1. Field

Example embodiments generally relate to an insert slot adapted to hold tool and grip inserts in a slip assembly, and to a method of forming the insert slot in the slip assembly.

2. Related Art

Conventionally at an oil rig site, slip assemblies or “rotary slips”, both manual (such as drill collar slips, casing slips, and pipe slips such as rotary hand slips (which fit around the pipe and wedge up against the mater bushing to support the drill pipe)) and powered rotary slips (pipe slips that are air or hydraulically-operated) are employed to hold certain tool inserts or grip inserts against drill pipe. FIG. 1 is a front view of conventional extra long rotary hand slip, and FIG. 2 is cross-sectional cut taken of the rotary hand slip attached to a portion of drill pipe. Referring to FIGS. 1 and 2, there is shown a conventional extra long rotary hand slip 100. Slip 100 includes three slip segments 110, handles 120, with each slip segment 110 having an insert slot holding a set of inserts 115 which are designed to interface and grip a pipe 150 under actuating tension of a pin drive master bushing 130 and bowl 140 on the slip 100 (slip segments 110). Typically, stresses imparted in this operation may be uneven on the insert 115, sometimes causing bowing at the toe 125 of the segment 110, to where the toe 125 may break off and fall into the drill hole.

FIG. 3 is a top view of a portion of a slip segment showing the toe of conventional insert slot design for inserts; and FIG. 4 is a side view of FIG. 3 on a slip segment. The conventional insert slot 116 for an insert 115 employs a design using a half-moon shaped button 117 to finish out the bottom of the dove tail insert groove 119. The half moon-shaped button 117 is a cast part and is put in place and welded, as shown by weld 118. The problem with this conventional insert slot design is that under stress of the weight on the inserts 115 (not shown) down on it, the cast part of the half moon 117 wants to shear the groove 119 due to the weight load. Also if the bottom of the insert 115 is tapered and does not sit on the insert slot 116 flat, the insert 115 often will pop out of the slot 116. Further, the insert 115 must be installed tight in the cutout for slot 116 or the weld 118 will break.

Another way for conventional insert slot design is to simply cut a slot straight across the bottom of the dove tail in the slip segment 110. This creates a gap and a flat bottom. The problem with this design is the cut weakens the toe 125 of the slip segment 110. This can cause the toe 125 to bend, permitting the insert 115 to come out.

FIG. 5 is a photograph of a top view of a portion of a slip segment showing the conventional insert slot design at the segment toe without inserts therein; and FIG. 6 is a photograph of a top view of a portion of a slip segment showing the conventional insert slot design with inserts installed in the slot channel. FIGS. 5 and 6 show the issues discussed above with the conventional half-moon insert slot design. Referring to FIG. 5 it can be seen in the picture without insert 115 installed that a half-moon button 117 welded piece is in place.

Several issues with this design introduce problems. First, the slot 116 has to be machined into the toe 125 area. This area can flex or move during use, causing the button 117 to come out or loosen up. Secondly, the button 117 may not fully seat against the bottom dovetail cutout 119 formed in the slip segment 110 as the insert slot 116; thus the weight of the insert 115 would be resting on the weld 118 and not supported by slot 116. Third, and as shown in FIG. 6, when the insert 115 is installed, an interface between the bottom of the insert slot 116 and the top of the button 117 becomes very critical. If the insert 115 rests on the back edge of the half moon button 117, it will cause the half moon button 117 to pop out.

In FIG. 6 with the insert 115 installed in the slot 116, a crack can be seen around the half moon button 117. The crack (small chips in weld 118 that follows arc of button 117) has formed because the insert 115 was not fully resting on the milled insert slot 116 when the half moon button 117 was welded in place; thus the insert 115 could break out. FIG. 6 also shows how much closer the slot 116 had to be milled to the end of the slip segment that is represented by the toe 125 area.

Accordingly, with the conventional insert slot designs, the weight of the insert can sit on the weld 118, the half-moon button 117 can crack or break, and stresses on these parts can force the toe 125 of the slip segment 110 to break off into the drill hole. If the bottom angle of the inset groove is greater than 1 degree from back to front, it will not create a stable level bottom groove for the insert, acting as a cam surface to create a shear weight interface between the top of the half moon button 117 and where the bottom of the softer metal insert sits on it. As this interface is critical, the weld 118 of the half moon 117 will crack or the half moon 117 will simply pop out of its weld 118.

In fabrication, the half-moon is imprecisely saw cut, and the insert slot is milled cut. So, due to the angle on the bottom of the back surface of the insert slot 116 within the slip segment 110 being less than 90 degrees, this causes shear stress to pop the half-moon 117 out of the insert slot 116.

Another critical problem with the conventional 2-piece insert slot design (slot 116 and half-moon button 117) as exemplified in FIGS. 1 through 6 is that for any manual/powered rotary slip or slip segment thereof that includes this insert slot design, it is simply not possible to determine, measure or assess an accurate load rating. This is because the fact that in any load test performed, because of the way it is manufactured, it is not possible to get a repetitive or same load test result. Specifically, it is impossible to get an accurate load rating for the conventional insert slot due to the way it is made. The half-moon button 117 can never be installed the same each time, it various as it is a separate piece, so in any load test, the half-moon button 117 will always come loose or break at different loadings in each load test. The two-piece insert slot design can never be as strong as a single piece design, as to be described hereafter.

This is especially important given the most recent December 2015 revisions in the now Sixth Edition of the American Petroleum Institute's (API) Specification 7K, Drilling and Well Servicing Equipment standards. Namely, Section 9.5 of the API 7K standard, applicable to all manual and powered rotary slips, now requires that an accurate load rating (i.e., how much load a slip can take before failure) for these rotary slips be determined.

More specifically, sub-section 9.5.2 now requires accurate load rating determinations for each of the various types of rotary slips. As part of its manufacture, an accurate load rating must be determine for each type of rotary slip, as specified, load ratings of 150 short tons or less for drill collar slips, 250 and 350 short tons for certain rotary pipe slips (manual or powered), and 500 short tons or more for casing slips and certain other rotary pipe slips (manual or powered). For slip assemblies which are rated ≦500 short tons, the load rating applies to the individual slip segment so long as the combined group of slip segments does not exceed 500 short tons. For all slip assemblies load rated >500 short tons, the particular group of slip segments are to be load rated as an assembly, proof load tested as a complete assembly and remain together as an inseparable assembly for its intended use. Accordingly, an insert slot design which enables any rotary slip to be accurately load tested so as to meet the new API 7K load rating requirements for rotary slips is needed.

### SUMMARY

An example embodiment is directed to an insert slot of a rotary slip assembly used in drilling operations, the slip assembly including one or more slip segments, each slip segment including one of more insert slots formed therein, each insert slot configured to secure a corresponding tool or grip insert for gripping a section of drill pipe under tension therein. The insert slot includes a generally rectangular recess formed by milling a single piece of metal which is to be the slip segment, the milled recess thereby forming the insert slot, and a circular hole formed at each of two lower corner locations of the milled recess. The circular corner holes allow a dovetail cutter access into and removal from the recess to make a dovetail cut that creates an angled grove along lengthwise sides of the insert slot, the insert slot having a flat bottom adapted to support a bottom of a tool or grip insert, the insert slot formed in a single piece of metal with no other materials attached thereto, so as to permit an accurate load rating to be determined for the slip assembly.

Another example embodiment is directed to a method of fabricating an insert slot for a slip segment of a rotary slip assembly. The method includes straight end milling a billet of metal serving as the slip segment to a first depth to form a generally rectangular-shaped insert slot therein, square end milling the billet to square the corners of the insert slot and to form a flat bottom so that a bottom of an insert will sit flat on the bottom of the insert slot, flat end milling the billet at two lower corners of the formed insert slot to create circular corner holes so as to allow access for a dovetail cut, and applying a dovetail cut to create a groove along lengthwise sides of the insert slot, the circular holes allowing for the dovetail cutter to be removed. No other materials are attached to the insert slot so as to permit an accurate load rating to be determined for the slip assembly. Also, the milling to form the corner holes prior to dovetail cutting permits the grooved sides to be cut in by the dovetail cut, thereby enabling the insert slot to be formed as a single piece in the slip segment.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a front view of conventional extra long rotary hand slip.

FIG. 2 is cross-sectional cut taken of the rotary hand slip attached to a portion of drill pipe.

FIG. 3 is a top view of a portion of a slip segment showing the toe of conventional insert slot design for inserts.

FIG. 4 is a side view of FIG. 3 on a slip segment.

FIG. 5 is a photograph of a top view of a portion of a slip segment showing the conventional insert slot design at the segment toe without inserts therein.

FIG. 6 is a photograph of a top view of a portion of a slip segment showing the conventional insert slot design with inserts installed in the slot channel.

FIG. 7 is a top view of a portion of a slip segment showing the toe of an insert slot design for inserts according to an example embodiment.

FIG. 8 is a side view of FIG. 7 on a slip segment.

FIGS. 9A to 9E illustrates a process for fabricating an insert slot in a slip segment according to an example embodiment.

FIG. 10 is a photograph of a top view of a portion of a slip segment showing the insert slot design of the example embodiment at the slip segment toe without inserts therein.

FIG. 11 is a photograph of a top view of a portion of a slip segment showing the insert slot design of the example embodiment with inserts installed in the slot channel.

FIG. 12 is a photograph of a test apparatus used to test the strength of a segment toe with the insert slot design of the example embodiment.

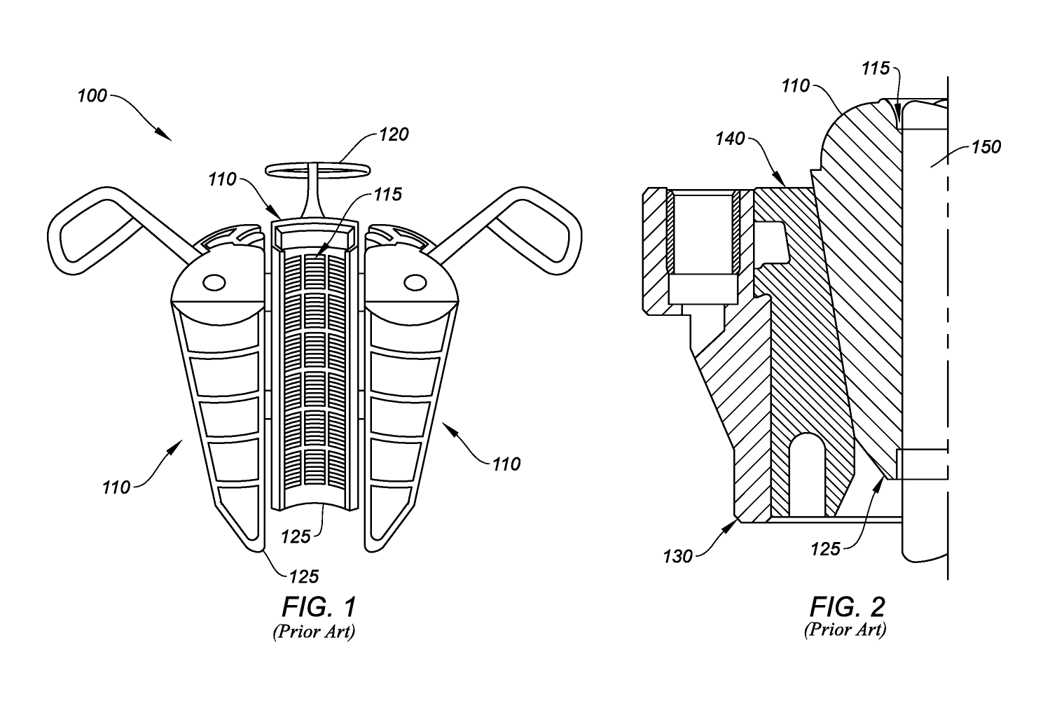

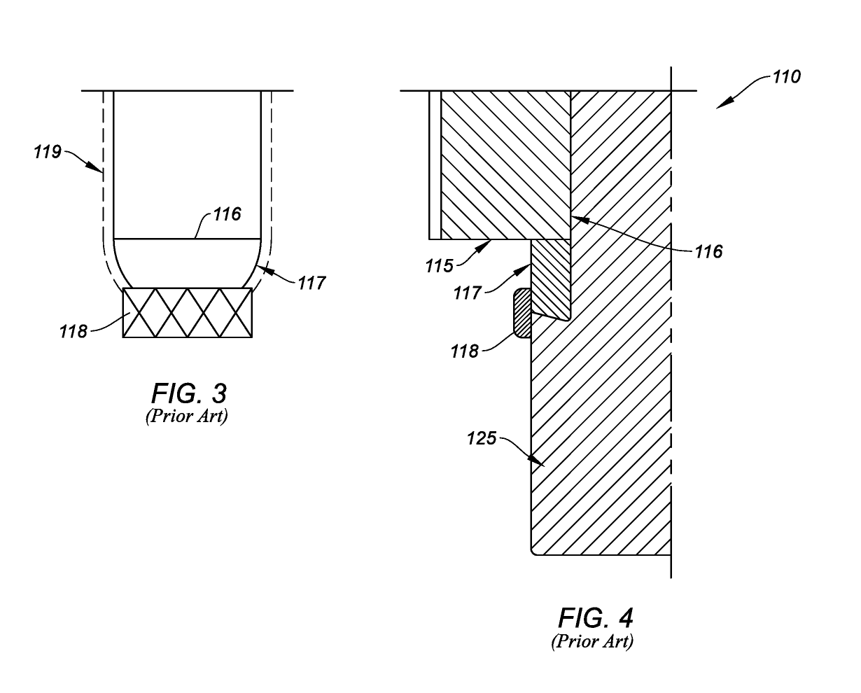

### DETAILED DESCRIPTION

As to be described hereafter, an example embodiment is directed to an insert slot for inserts of rotary slip assemblies and to a method of forming the insert slot in the slip assembly.

As to be shown hereafter, a novel design for an insert slot to hold tool inserts or grip inserts in various rotary slips (drill collar slips, hand/powered rotary pipe slips, casing slips, etc.) may provide a slip segment with an insert slot that based on testing is 20% stronger than the conventional insert slot design described above. The example insert slot to be described hereafter is not subject to the limitations of the conventional insert slot. Namely, by having a flat bottom on the groove at the bottom of the insert slot, unlike the 2-piece insert slot with half-moon button style of the conventional design, an accurate load rating may be determined for the rotary slip and/or for a slip segment thereof.

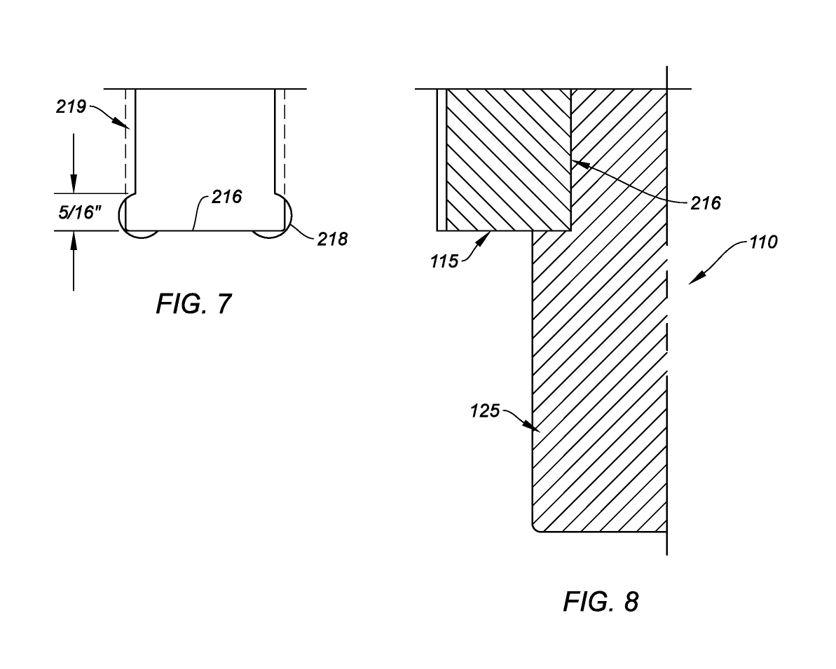

FIG. 7 is a top view of a portion of a slip segment showing the toe of an insert slot design for inserts according to an example embodiment, and FIG. 8 is a side view of FIG. 7 on a slip segment. Referring to FIGS. 7 and 8, the insert slot 216 of the example embodiments employs milled corner holes 218. As such, these holes 218 are above the toe 125 area so as not to be in the flex zone where there could be a radial stress causing toe 125 breakage into the pipe hole. This was not possible with the half-moon design because the half moon design must be machined into the toe area due to its size. In the conventional design, the toe area is filled back in by the half moon but it is not solid. It is only a weld attachment in one spot.

The design described herein, on the other hand, is a solid design in this area, so any flex or movement will not cause failure of the toe 125. The new design is much stronger due to the fact that it remains above and hence out of the toe 125 area.

Also, no weldments are required. There is no extra half-moon welded piece, so the issue of potential gaps or mismatch between a welded closeout and cast material (i.e., half-moon and slip segment) has been eliminated. Thus, all the material for the insert slot 216 is made of casting; this means that the tensile properties and yield of the material can be definitively known and tested, i.e., what it takes to break it. Designers can therefore have a constant and can accurately determine the load rating per the API 7K spec for the slip 100, e.g., how much weight the slip 100 will hold before it breaks. Since the insert slot 216 is made out of a single piece, it may be load tested and verified so that it breaks at the calculated load; and it will break every time at the same load, thus complying with the API 7K spec.

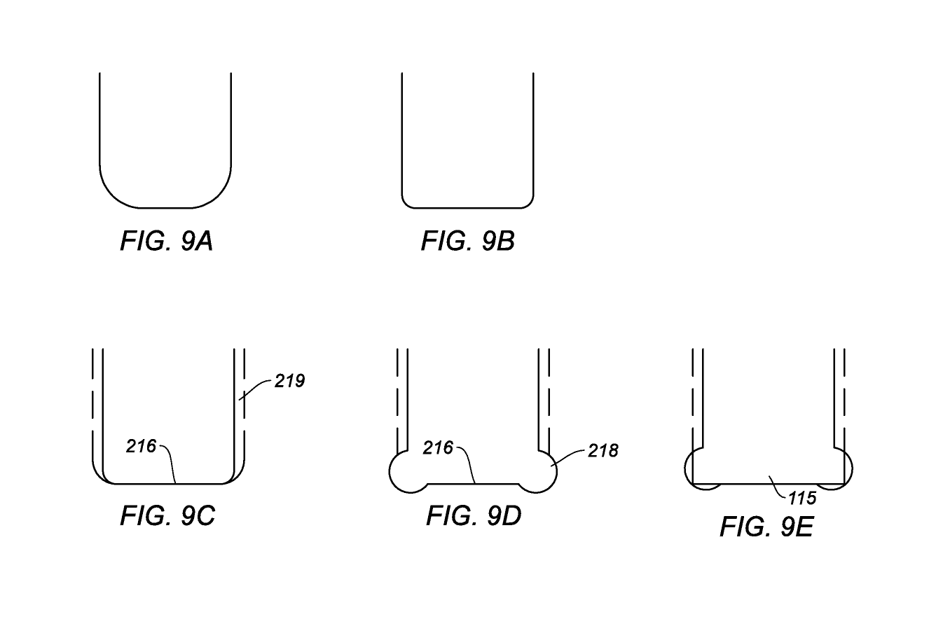

FIGS. 9A to 9E illustrates a process for fabricating an insert slot in a slip segment according to an example embodiment. Unlike the conventional insert slot 115 having two pieces, (a slot 216 formed in the slips segment 110 and the welded-in half moon button 117 located at the bottom of the slot 116), here the example insert slot is formed in a single piece or casted material that is to be the eventual slip segment 110, without any additional materials or weldments. Initially in FIG. 9A, a piece of cast steel billet that will form slip segment 110 with the insert slot 216 therein is milled using precision computer numerically controlled (CNC) machining centers, such as in a straight end mill with a straight mill ¾″ cut. Next, at FIG. 9B, a 5/16″ square end mill cut is applied to make the radiuses of the eventual corner holes 218 a bit smaller and square the corners. This cut also is needed to start forming what will be an eventual flat bottom in the eventual slot 216, so that a bottom of insert 115 will sit flat thereon. In FIG. 9C, a dovetail cutter is employed to groove a 15° angled groove (½″ deep cut) down both vertical sides of the billet, top to bottom (see dotted lines). This is done down the length of the slip segment 110. However, this is done after the corner holes 218 have been pre-cut, as described in FIG. 9D.

To create the corner holes 218, a flat (trig) end mill creates a ⅜″ deep hole with a ⅛″ radius (FIG. 9D) so as to relieve the corners at the bottom of the slip segment 110 and thus form the bottom of the insert slot 216. These holes 218, which are “pre-cut”, drilled or otherwise formed at lower opposed corners of the milled recess that eventually becomes the insert slot 216 in a slip segment 110, are pre-cut in the recess to provide a way during manufacturing of the insert slot to remove the dovetail cutter, thereby allowing for the insert slot 218 to be cut with a flat bottom from a single piece of material.

More specifically, the dovetail cutter as discussed above is used to cut the angled grooves (FIG. 9C) on the sides of the insert slot 216. When the cutter gets to the bottom of the insert slot 216, it cannot finish the slot 216 to the bottom unless these holes are precut in the corners. By pre-cutting or pre-forming the holes in the corners, a side taper can be cut to the bottom edge of the slot 216 and the dovetail cutter can then be removed. This also allows the insert slot 216 to be cut into a single piece of steel, making the insert slot 216 stronger. Additionally, because the yield of the steel is a known value, the load rating of the insert slot 216 can be calculated and verified by a load test. This allows the slip 100 design to be calculated and tested per the API 7K slip design requirement. And because the insert slot design is manufactured repeatedly the same way, the slip 100 can be accurately rated for working loads.

FIG. 9E shows what an insert 115 would look like in the completed insert slot 216, flush against the bottom interior flat surface of the insert slot 216, with the corners 218 providing ample space for the ends of the insert 115.

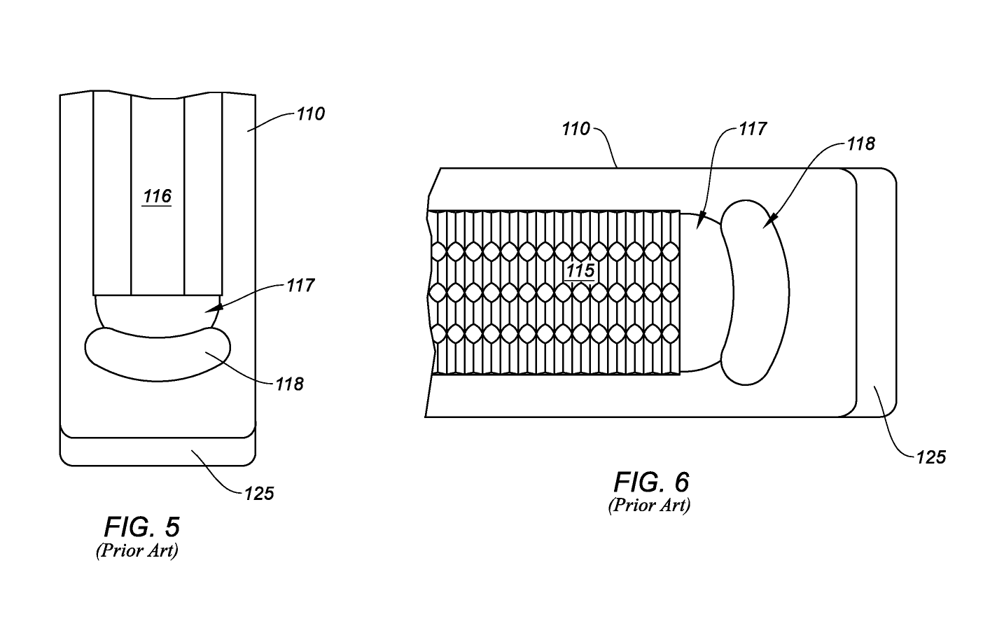

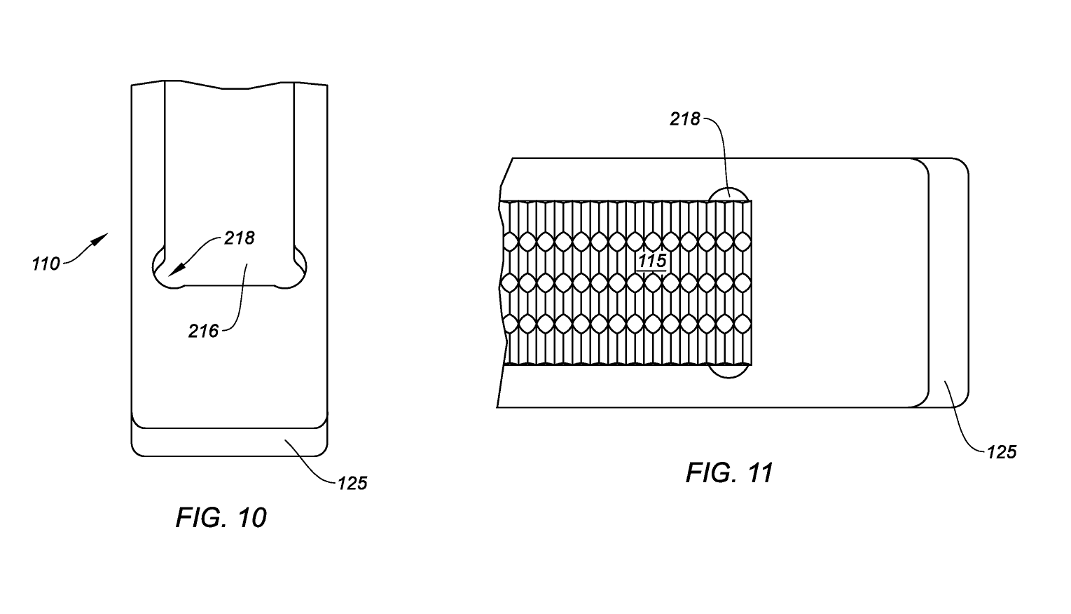

FIG. 10 is a photograph of a top view of a portion of a slip segment showing the insert slot design of the example embodiment at the segment toe without inserts therein, and FIG. 11 is a photograph of a top view of a portion of a slip segment showing the insert slot design of the example embodiment with inserts installed in the slot channel. In FIG. 10, the insert slot 216 design has no separate parts welded in, and machining stops above the toe 125 area. Additionally, it does not matter how the insert 115 (not shown) rests on the bottom of the slot 216. FIG. 11 shows the example slot 216 design with the insert 115 installed. The machining stops ¾″ above where the conventional design does, and does not extend into the toe 125 area like the conventional half-moon design of FIGS. 5 and 6.

As can be seen, for insert slot 216 there is no welded-in part; the interface between the bottom of the insert 115 and the slot 216 does not matter, and this design is easily repeatable and can be controlled for accurate load testing. Accordingly, this design makes the insert slot 216 up to 20% stronger than the 2-piece design of the conventional insert slot 116. Also, it enables one to perform a load test to determine a known and accurate load rating for the slip segment and/or rotary slip which includes the slots 216. This is not possible with the conventional 2-piece slot insert slot 116.

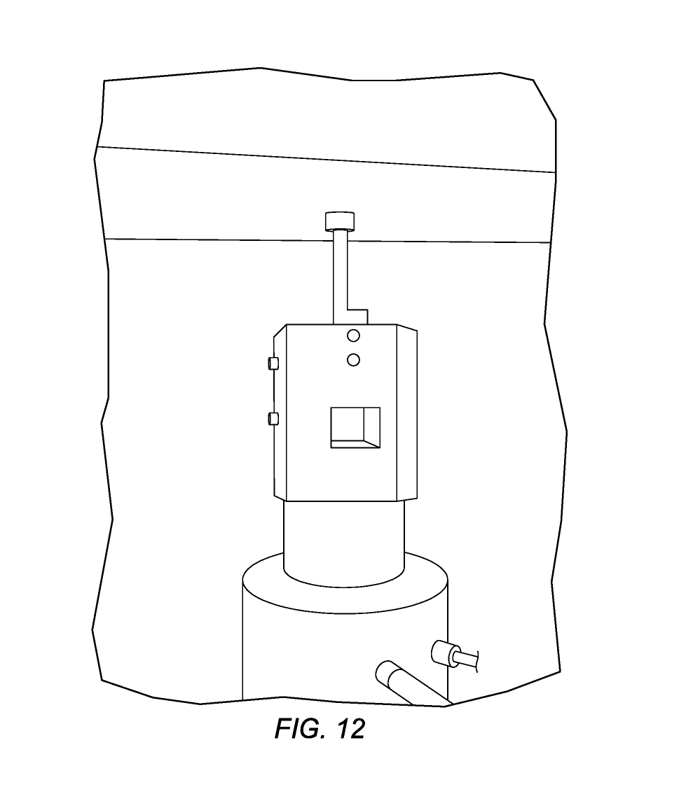

FIG. 12 is a photograph of a test apparatus used to test the strength of a segment toe with the insert slot design of the example embodiment. The apparatus of FIG. 12 is a hydraulic ram pushing an insert down into an insert slot. This apparatus was set to test and measure the load rating, i.e., force needed to break an insert slot of a slip segment (at the toe area of the slip segment) for any type of slip (power slip, hand slip, etc.). Both the conventional half-moon insert slot design and the example insert slot design described herein were tested.

A sampling was done every hundredth of a second. Two (2) strain gauges were used to measure force at two (2) separate locations: (a) strain at the toe 125 (flex in the toe); (b) strain at where the bottom of the insert 115 sits in the insert slot 116/216. The following TABLE summarizes the results from this comparative test.

TABLE

| | Generic | Generic | |
|---|---|---|---|
| | 350 Ohm | 350 Ohm | 400 Ton jack on |
| | Uniaxial | Uniaxial | Channel 1 |
| | Strain Gage | Strain Gage | calibrated |
| | on channel 1 | on channel 2 | values |
| | [001] | [002] | 121 (lb) |
| | MAX Strain | MAX Strain | Maximum |
| Half-Moon Design | 4906 | | 88887 |
| Half-Moon Design | | 8879 | 96446 |
| Example Embodiment | 8192 | | 104004 |
| Example Embodiment | | 9638 | 104004 |

Referring to the Table, for the channel 1 strain in the toe area, the example embodiment showed about a 17% improvement in strength before failure (failing at 104004 lb versus 88887 for the half-moon design). For the insert slot/insert strain point, the example embodiment showed about an 8% improvement. Over a series of test runs, the new design showed an approximate 20% strength improvement as compared to the conventional insert slot design.

The example insert slot and method of making thereof may be applicable to all rotary slips, both manual and powered. The slip assembly employing this insert slot technology provides a slip segment which is made repeatable and allows the manufacturer to provide a constant to accurately load rate these rotary slips, something heretofore which has not been contemplated in the industry.

The example embodiments being thus described, it will be obvious that the same may be varied in many ways. Such variations are not to be regarded as departure from the example embodiments, and all such modifications as would be obvious to one skilled in the art are intended to be included in the following claims.

I claim:

1. An insert slot of a rotary slip assembly used in drilling operations, the slip assembly including one or more slip segments, each slip segment including one of more insert slots formed therein, each insert slot configured to secure a corresponding tool or grip insert for gripping a section of drill pipe under tension therein, comprising:
a generally rectangular recess formed by milling a single piece of metal which is to be the slip segment, the milled recess thereby forming the insert slot, and
a circular hole formed at each of two lower corner locations of the milled recess, the circular corner holes allowing a dovetail cutter access into and removal from the recess to make a dovetail cut that creates an angled grove along lengthwise sides of the insert slot, the insert slot having a flat bottom adapted to support a bottom of a tool or grip insert, the insert slot formed in a single piece of metal with no other materials attached thereto, so as to permit an accurate load rating to be determined for the slip assembly.

2. The insert slot of claim 1, wherein the slip segment has a toe area at a lower end thereof, the corner holes being located above the toe area so as not to be in a flex zone area subject to radial stress which can break the toe off.

3. The insert slot of claim 1, wherein the insert slot is weld-free.

4. The insert slot of claim 1, wherein the single piece of metal serving as the slip segment is made of casted metal materials.

5. The insert slot of claim 4, wherein the casted materials which form the slip segment with insert slot therein permit tensile properties and yield thereof to be accurately known and tested.

6. The insert slot of claim 1, wherein the rotary slip assembly is a manual slip.

7. The insert slot of claim 6, wherein the manual slip is selected from a group consisting of a rotary hand pipe slip, a drill collar slip, and a casing slip.

8. The insert slot of claim 1, wherein the slip assembly is an air or hydraulically-powered pipe slip.

9. A method of fabricating an insert slot for a slip segment of a rotary slip assembly, comprising:
straight end milling a billet of metal serving as the slip segment to a first depth to form a generally rectangular-shaped insert slot therein,
square end milling the billet to square the corners of the insert slot and to form a flat bottom so that a bottom of an insert will sit flat on the bottom of the insert slot,
flat end milling the billet at two lower corners of the formed insert slot to create circular corner holes so as to allow access for a dovetail cut, and
applying a dovetail cut to create a groove along lengthwise sides of the insert slot, the circular holes allowing for the dovetail cutter to be removed, wherein
no other materials are attached to the insert slot so as to permit an accurate load rating to be determined for the slip assembly, and
the milling to form the corner holes prior to dovetail cutting permits the grooved sides to be cut in by the dovetail cut, thereby enabling the insert slot to be formed as a single piece in the slip segment.

10. The method of claim 9, wherein straight end milling further includes applying a ¾″ deep straight mill cut to the billet to form the insert slot therein.

11. The method of claim 9, wherein square end milling further includes applying a 5/16″ deep square mill cut to the billet to square the corners.

12. The method of claim 9, wherein applying the dovetail cut includes employing a dovetail cutter to groove a 15° angled groove at a depth of ½″ down both vertical sides of the billet, top to bottom.

13. The method of claim 9, wherein flat end milling includes employing a flat end mill to create a ⅜″ hole at a radius of ⅛″ so as to form the circular corner holes.
